(19) United States
(12) Patent Application Publication
(10) Pub. No.: US 2005/0198265 A1
(43) Pub. Date: Sep. 8, 2005

(54) Method and apparatus for information notification

(76) Inventors: Peter Veprek, Santa Barbara, CA (US); Steven Pearson, Santa Barbara, CA (US)

Correspondence Address: HARNESS, DICKEY & PIERCE, P.L.C., P.O. BOX 828, BLOOMFIELD HILLS, MI, 48303, US

(21) Appl. No.: 10/769,155

(22) Filed: Jan. 30, 2004

(51) Int. Cl. G06F 15/173

(52) U.S. Cl. 709/224

(57) ABSTRACT

An information notification system includes an input receiving activity information relating to a user activity category and/or environment information relating to a user environment category. A delivery module determines a manner of notification delivery based on the user activity category and the user environment category. An output communicates a notification to the user in accordance with the manner of delivery.

### FIELD OF THE INVENTION

The present invention generally relates to information notification systems and methods, and particularly relates to intelligent delivery of information notifications based on factors such as user activity and user environment.

### BACKGROUND OF THE INVENTION

Today's information notification delivery systems and methods typically deliver notifications to users as quickly as possible. As a result, a device may attempt to communicate notifications to a user when the user is not present. It is also possible that delivery of an important notification may be delayed while less important notifications are communicated to the user. Even where notification priority is taken into account, the delivery of the notification may occur at a time or place that is inconvenient, uncourteous, untimely, unnatural, or unsafe.

Purely blind delivery of notifications without regard to a user's situation may inconvenience, offend, dissatisfy, anger, or even endanger a user. Therefore, the need remains for a notification delivery system and method that accomplishes convenient, courteous, timely, natural, and safe delivery of notifications. The present invention fulfills this need.

### SUMMARY OF THE INVENTION

In accordance with the present invention, an information notification system includes an input receiving activity information relating to a user activity category and/or environment information relating to a user environment category. A delivery module determines a manner of notification delivery based on the user activity category and/or the user environment category. An output communicates a notification to the user in accordance with the manner of delivery.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an entity relationship diagram illustrating a network distributed notification delivery system in accordance with the present invention;

FIG. 2 is a data flow diagram illustrating an information notification module for use with a notification delivery system in accordance with the present invention;

FIG. 3 is a data flow diagram illustrating user activity and environment category selection for use with an information notification module in accordance with the present invention;

FIG. 4 is a data flow diagram illustrating a notification delivery module for use with an information notification module in accordance with the present invention; and

FIG. 5 is a data flow diagram illustrating user preference tracking for use with a notification delivery module in accordance with the present invention.

### DETAILED DESCRIPTION OF THE PREFERRED EMBODIMENTS

The following description of the preferred embodiments is merely exemplary in nature and is in no way intended to limit the invention, its application, or uses.

By way of overview, a number of examples of notification delivery in accordance with the present invention are illustrated below. In one example, the system employs available sensing devices and/or deduced time patterns relating to the user's past behavior to infer that the user is not present. Accordingly, the system delays delivery of a notification until the user is present. In another example, the system employs available sensing devices and/or deduced time patterns relating to the user's behavior to infer that the user is occupied by a task of a particular priority. Accordingly, the system determines whether to delay delivery of the notification by comparing a priority of the notification to the priority of the task the user is performing.

In yet another example, the system first initiates a non-intrusive attention grabbing gesture. Next, the system observes the user's response through the available sensing devices. Then, the system determines whether to deliver the notification based on the user's response, if any. In a further example, the system first initiates an interaction with the user in the form of a dialog. Next, the system observes the user's response through the available sensing devices. Then, the system determines whether to deliver or delay delivery of pending notifications based on the user's response, if any. In a yet further example, the system interrupts the user from a current task of low importance and delivers a notification of relatively high importance. In a still further example, the system attempts to gain the user's attention and analyzes the user's response and its emotional content. Thus, an angry “Not now!” or an unusually forceful tap on a touchpad may be perceived by the system as an unfavorable reaction. From the analysis, the claimed system determines whether the reaction was favorable or unfavorable and incorporates this knowledge into future interactions with the user.

In an additional example, the system learns or adapts to new or changed behavior of the user or environment. In an additional example, the system discards expired notifications. The notification delivery system may temporarily or permanently archive expired notifications so that the user can still retrieve them by special request. It is envisioned that notifications may also have activation times indicating that a notification should not take place until some point in the future. In an additional example, the system analyzes a queue of pending notifications. Older notifications that have been superseded by newer notifications of similar type are discarded in favor of the newer notifications. It is also envisioned that notifications may have expiration times indicating that a notification should be discarded after this time has passed. In a final example, the system analyzes a queue of notifications and generates summary notifications. Other examples of notification delivery functionality will become readily apparent to those skilled in the art based on the following description, associated drawings, and appended claims.

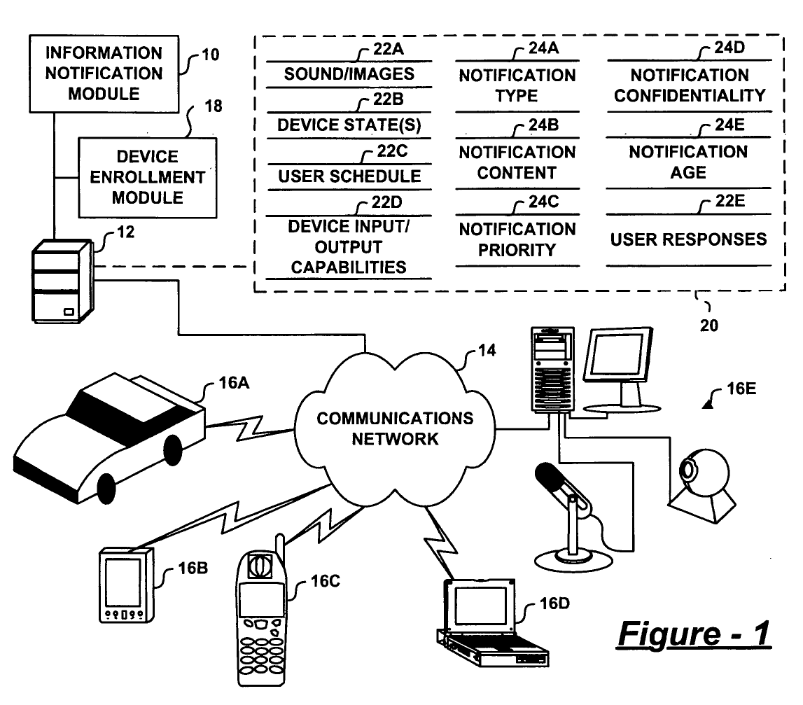

An apparatus implementing the present invention may be a desktop computer, hand-held computer, mobile device, industrial appliance, network service, vehicle telematics system, entertainment system, medical device, or any other apparatus that periodically needs to deliver a notification to a user. The system of the present invention may be singularly implemented aboard a particular device, or may be distributed among devices via a communications network. This second instance is illustrated in FIG. 1.

A network distributed embodiment of the notification delivery system includes an information notification module 10 deployed by server 12 over communications network 14, such as the Internet. Various electronic devices, such as automobile navigation system 16A, personal digital assistant 16B, cell phone 16C, laptop computer 16D, and desktop computer 16E are adapted to operate in accordance with the present invention. In some embodiments, devices 16A-16E are operable to cooperatively accomplish notification delivery in accordance with the present invention. In other embodiments, each device 16A-16E is adapted by an application program interface (API) specific to the type of device. This API overwrites the device's methods relating to notification delivery. As a result, each device 16A-16E sends its original notifications to server 12 and delivers notifications received from server 12 to users in accordance with instructions from server 12. Also, the API adapts each device 16A-16E to register with server 12 via device enrollment module 18, thereby providing information on its capabilities 22D to communicate notifications to a user and/or receive user feedback. Further, the API causes each device 16A-16E to continuously or periodically communicate captured sounds and images 22A, user schedules 22C, and device states 22B to server 12. User responses to attention grabbing gestures and notifications are therefore communicated to server 12 in the form of captured sounds or images 22A and/or user interaction with a device that is reflected in device states 22B. These inputs 22A-22C plus device input/output capabilities 22D, user responses 22E, and with notification characteristics including type 24A, content 24B, priority 24C, confidentiality 24D, and age 24E, are used by information notification module 10 to deliver notifications in a convenient, courteous, timely, natural, and safe way. User interaction with a device can also set and/or temporarily override user preferences. For example, a user may set a preference on a device not to be disturbed, and later request delivery of notifications at a convenient time, one time only, while leaving the preference not to be disturbed by automatic notification delivery in place.

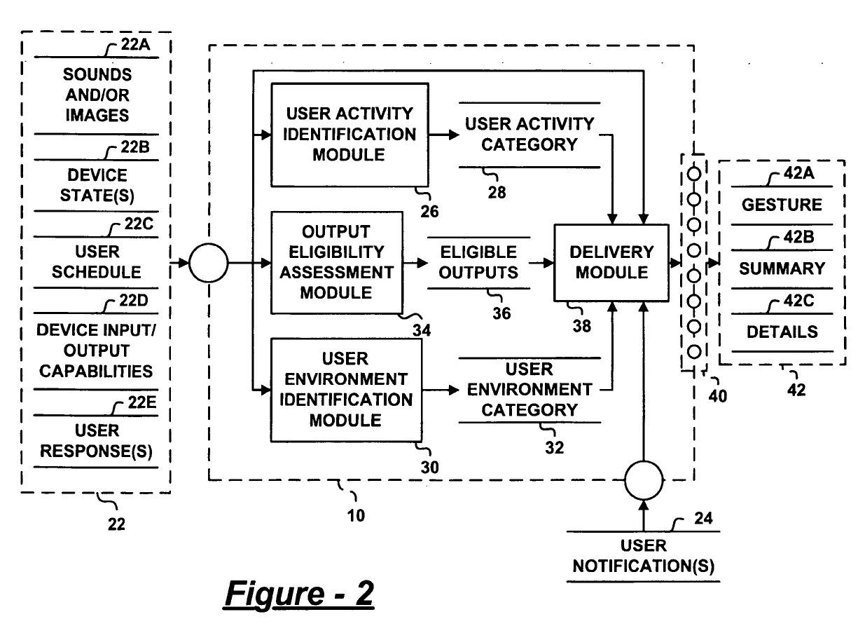

Turning now to FIG. 2, information notification module is illustrated in greater detail. Device input 22, including sounds and/or images 22A, device states 22B, user schedule 22C, device input/output capabilities 22D, and user responses 22E, are received by information notification module 10. These device inputs are communicated to user activity identification module 26, output eligibility assessment module 34, user environment identification module 30, and delivery module 38. In turn, user activity identification module 26 and user environment identification module 30 are respectively operable to select a user activity category 28 and a user environment category 32 based on the received input 22, and to communicate the selected categories to delivery module 38. Output eligibility assessment module is operable to identify eligible outputs 36 based, for example, on observed user collocation with devices having the outputs.

Delivery module 38 receives a notification 24 and determines a manner of delivery 42 based on the total situation. For example, delivery module 38 considers characteristics of the notification 24, the user activity category 28, the user environment category 32, and capabilities of the eligible outputs 36. The manner of delivery 42 includes components relating the choice of available outputs 40 and their associated media, and the form taken by the notification. Possible forms include a detailed notification 42C, a summary notification 42B leaving out non-essential details, and an attention grabbing gesture 42A.

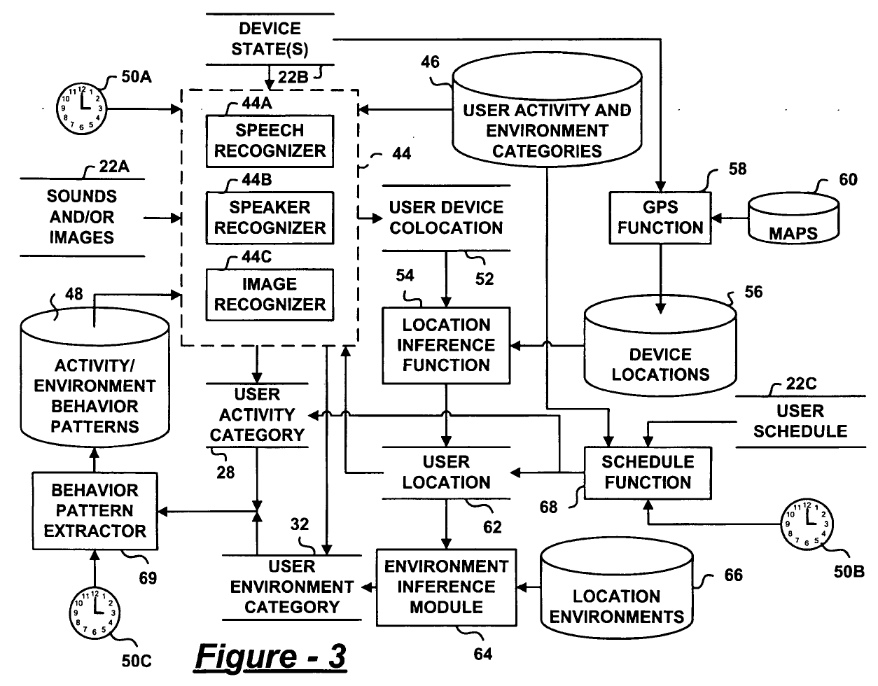

Turning now to FIG. 3, details relating to the user activity and environment category selection are illustrated. An interpretation module 44 receives sounds and or images 22A and interprets the sounds and images 22A using a speech recognizer 44A, speaker recognizer 44B, image recognizer 44C, and other types of recognition modules to interpret the sensed input. It is envisioned that peripheral devices may be operable to perform some or all of the recognition and send recognition results in lieu of the captured sounds and images 22A. Interpretation module is operable to match recognition results with one or more of plural user activity and environment categories in datastore 46 to produce user activity category 28 and/or user environment category 32. Alternatively or in addition, interpretation module 44 receives device states 22B and determines whether a user is currently interacting with or has recently interacted with one or more of the user devices. As a result, interpretation module identifies collocation 52 of the user and one or more devices.

Collocation 52 may also be identified using facial or speaker recognition to identify a user in proximity to one or more of the devices. Device recognition may further be implemented. For example, the user may have an MP3 player hanging on his/her neck that is capable of receiving audio via BlueTooth. In this case, the system may use the player for audible notifications, but the device is portable and may not have GPS capabilities. Nevertheless, if another device has a camera (that can be used to detect and recognize the user's face), the camera could also be used to detect the device hanging on the user's neck, i.e. the system could ‘see’ (detect/recognize) the camera visually and thus locate it as in the vicinity of the user. Another way to recognize a device is by its audible signature. For example, one could use sound emitted by a phone or a computer fan to determine the device is nearby. A further way to recognize a device is by a device beacon. For example, it may be possible to detect a cell phone, but only have its telephone number. Similarly, one may be able to ‘ping’ a computer, but all one may have is its network address. Therefore, the system may be in communication with a device, but not be sure of its precise location. However, the device may have some kind a beacon, active or passive, that the system could detect, such that the system knows that the device is nearby and can be used to communicate with the user. One example of such beacons is RFID tags. Therefore, if a sensor of the system detects an RFID tag of the user's phone collocated with user's present location, then the system can notify the user via the phone.

Once collocation of a user and device have been established, an inference of the location 62 of the user may then be made by function 54 based on known device locations of datastore 56. These locations may be stored data relating to location of a stationary device, such as a desktop computer in a user's home office. Alternatively or additionally, these locations may be the result of a global positioning system (GPS) function 58 applying maps 60 to determine the location of portable devices having GPS functionality and communicating device position as part of device states 22B. The user location 62 may then be used by environment inference module 64 to determine user environment category 32 based on known location environments 66. Location 62 may also be used by interpretation module 44 to assist in determining the user activity category 28. It is envisioned that a device to environment correspondence may be equivalently affected, such as a known correspondence between a vehicle navigation system and a particular vehicle.

An alternative or additional way of determining user activity and user location includes use of a schedule function 68 to select one or more of categories 46 based on a user schedule 22C and a current time 50B. A yet further additional or alternative way of determining user activity and environment categories includes tracking user activity and environment behavior patterns 48. Behavior pattern extraction module 69 is operable to receive the selected categories and extract the behavior patterns 48 over time 50C. Then, interpretation module interprets the behavior patterns 48 with respect to a current time 50A to supplement or replace recognition functions. It is envisioned that similar functionality especially pertaining to determining user device collocation further pertain to determining device eligibility. Other information in device states 22B also help to inform the system which devices are operational and set to communicate with the user via one or more outputs of known character.

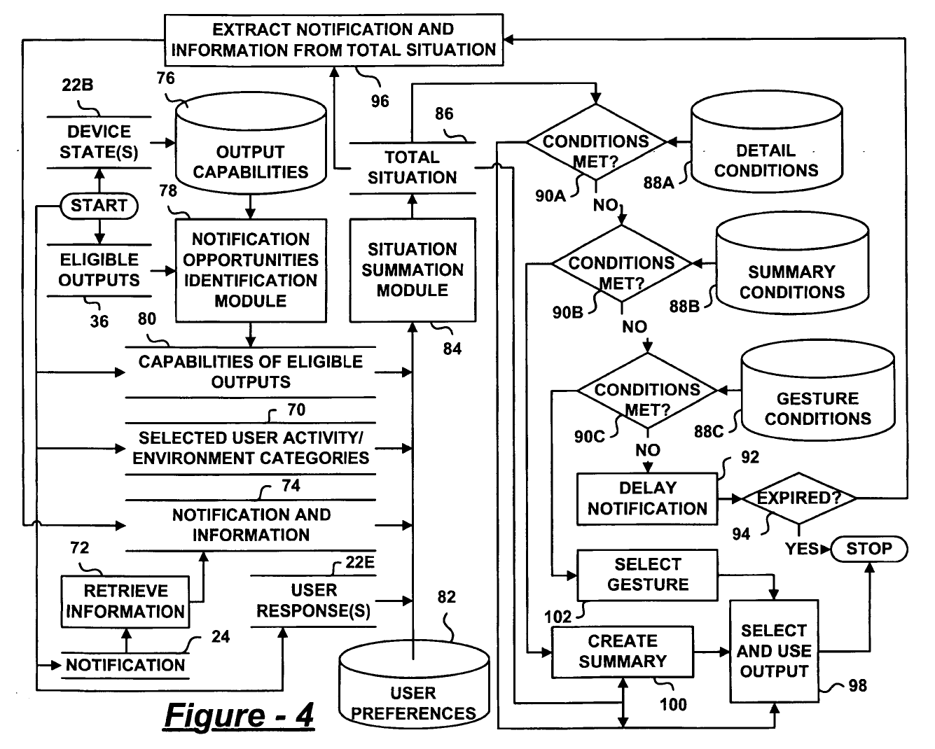

Turning now to FIG. 4, details of delivery module functionality are illustrated. Various aspects of the total situation are initially assembled, including device states 22B, eligible outputs 36, the notification 24, and any previous user responses 22E to notification attempts respective of the notification 24. Additionally, the notification 24 is used to retrieve any other relevant information at 72 to produce notification and relevant information 74. For example, a notification that a user has a new email may be employed to retrieve some or all of the email content, including the subject line, sender, content, and any attachments. Further, the device states 22B are used to update the output capabilities 76 of the devices in accordance with user preferences expressed manually on the device. For example, the user may set a cell phone to vibrate mode only, and this change is appropriately reflected in the output capabilities of the device. Thus, notification opportunities identification module 78 identifies capabilities of eligible devices based on the eligible outputs 36 and output capabilities 76 that reflect manually expressed user preferences.

Situation summation module 84 is operable to generate total situation 86 by concatenating the capabilities of the eligible outputs 80, the selected categories 70, the notification and information 74, the user response 22E, and any previously expressed user preferences 82 in similar situations. The total situation is then evaluated at 90A, 90B, and 90C to determine if predetermined conditions 88A, 88B, and 88C are met relating to convenience, courtesy, timeliness, naturalness, and safety. If the conditions are not met, then the notification is delayed at 92 for a predetermined amount of time. Then the notification is discarded if it has expired as at 94. The expiration may be determined based on a time stamp of the notification, or it may be determined based on replacement of the notification with a new notification. If the notification is not expired, then the notification and information are extracted from the total situation and fed back into the process to obtain a new total situation 86 based on updated inputs.

If the conditions 88A are met for communicating details of the notification, then the entire notification is delivered to the user by an output selected at 98. A degree of detail may be selected based on previously determined user preferences 82 and user responses 22E. Thus, if the detailed notification is communicated to the user, then the user can request and receive more details about the related information.

If the conditions 88A for a detailed notification are not met at 90A, but the conditions 88B for a summary notification are met at 90B, then a summary is created at 100 and communicated to the user at 98. On the other hand, if the conditions 88B are not met at 90B, but the conditions 88C for an attention grabbing gesture are met at 90C, then an appropriate gesture is selected at 102 based on the available output capabilities, and the corresponding output is selected and employed at 98.

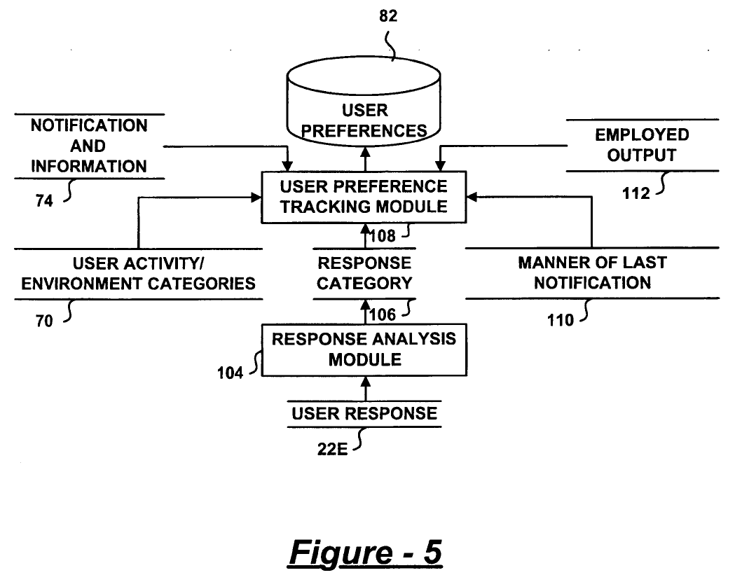

Turning now to FIG. 5, details relating to tracking of user preferences are illustrated. Accordingly, a user response 22E is analyzed by response analysis module 104 to determine an appropriate response category 106 relating to a degree of favor or disfavor with which the notification was greeted. Intensity of response is a factor that may de determined by volume of speech or force of touch. User preference tracking module 108 then records the response category 106 in user preference datastore 82 in association with related information. The related information includes the notification and information 74, the output employed 112, the user activity and environment categories 70, and the manner or form of the last notification 110, such as gesture, summary, or detail.

One skilled in the art will readily appreciate the many advantages of the present invention. For example, the user may receive a notification from one device, such as a home computer, via another device in the user's presence, such as a vehicle telematics system. The notification may be delayed while the user finishes a critical driving maneuver, such as a turn. Priority notifications, such as requested notifications may be reliably communicated to users in a timely manner. Confidential notifications may be delayed until the user is in a private setting, although the user may be made quietly aware of the existence of the confidential notification. Cell phones will not ring in a movie theater or client meeting, but will vibrate instead even though the user has not actively set the cell phone to a vibrate mode. A written email may be spoken to a user via a text-to-speech system over a cell phone based on available media and media of the notifications. A user may naturally respond to an attention grabbing gesture with a response that conveniently specifies the desired manner of notification. Yet further advantages will be readily apparent to one skilled in the art.

The description of the invention is merely exemplary in nature and, thus, variations that do not depart from the gist of the invention are intended to be within the scope of the invention. Such variations are not to be regarded as a departure from the spirit and scope of the invention.

1. An information notification system, comprising:
an input receptive of at least one of:
(a) activity information relating to at least one user activity category; and
(b) environment information relating to at least one user environment category;
a delivery module operable to determine a manner of notification delivery based on at least one of the user activity category and the user environment category; and
an output operable to communicate a notification to the user in accordance with the manner of delivery.

2. The system of claim 1, further comprising a user activity identification module operable to select at least one of plural, predefined user activity categories based on sensed user activity.

3. The system of claim 2, further comprising a user activity sensing module operable to sense user interaction with an electronic device via the electronic device.

4. The system of claim 2, further comprising a user activity sensing module operable to sense user interaction with a user environment via an electronic device proximate to the user environment and having a sensory function.

5. The system of claim 1, further comprising a user activity identification module operable to select at least one of plural, predefined user activity categories based on a time-specific user activity schedule and a current time.

6. The system of claim 1, further comprising a user activity identification module operable to select at least one of plural, predefined user activity categories based on learned user behavior patterns resulting from monitored user activity.

7. The system of claim 1, further comprising a user environment identification module operable to select at least one of plural, predefined user environment categories based on a user location and predefined environment categories associated in a datastore with at least one location.

8. The system of claim 7, further comprising a user location sensing module operable to sense the user location based on a global positioning system function of a portable electronic device of the user.

9. The system of claim 7, further comprising a user location sensing module operable to sense the user location based on a time-specific and location-specific user activity schedule and a current time.

10. The system of claim 7, further comprising a user location sensing module operable to sense the user location based on user interaction with an electronic device at a known location.

11. The system of claim 1, further comprising a user environment identification module operable to select at least one of plural, predefined user environment categories based on sensed environmental stimuli in proximity to the user.

12. The system of claim 1, further comprising a user environment identification module operable to select at least one of plural, predefined user environment categories based on learned environment behavior patterns resulting from monitored environment behavior.

13. The system of claim 1, wherein said delivery module is operable to determine the manner of notification delivery based on an information category relating to the notification.

14. The system of claim 13, further comprising an information categorization module operable to select at least one of plural information categories based on a priority of the notification.

15. The system of claim 14, wherein said delivery module is operable to determine the manner of delivery based on a comparison between the priority of the notification and a priority relating to a user activity.

16. The system of claim 13, further comprising an information categorization module operable to select at least one of plural information categories based on a confidentiality level of the notification.

17. The system of claim 13, further comprising an information categorization module operable to select at least one of plural information categories based on content of the notification.

18. The system of claim 13, further comprising an information categorization module operable to select at least one of plural information categories based on at least one medium of the notification selected from at least one of audio, video, text, image, vibration, sound, and light emission.

19. The system of claim 1, wherein said delivery module is operable to determine whether a manner of delivery is available that satisfies predetermined conditions relating to convenience, courtesy, timeliness, naturalness, and safety, wherein the manner of delivery relates to a medium of the notification in view of communication capabilities of eligible devices, wherein the medium is selected from at least one of audio, video, text, image, vibration, sound, and light emission.

20. The system of claim 19, wherein said delivery module is operable to determine that communication of an attention grabbing gesture satisfies the predetermined conditions.

21. The system of claim 20, wherein said input is further receptive of a user response to the attention grabbing gesture, and said delivery module is operable to determine whether a manner of delivery is available that satisfies the predetermined conditions based on the user response.

22. The system of claim 19, wherein said delivery module is operable to delay communication of the notification until the predetermined conditions are satisfied.

23. The system of claim 19, wherein said delivery module is operable to determine that communication of a full version of the notification satisfies the predetermined conditions.

24. The system of claim 19, wherein said delivery module is operable to determine that communication of a summarized version of the notification satisfies the predetermined conditions.

25. The system of claim 19, wherein said delivery module is operable to determine whether a manner of delivery is available that satisfies the predetermined conditions based on at least one communication capability of at least one device eligible to communicate the notification to the user.

26. The system of claim 1, further comprising a device eligibility assessment module operable to assess eligibility of devices to communicate the notification to the user.

27. The system of claim 26, wherein said delivery module is operable to select one of plural eligible devices to communicate the notification based on varying communication capabilities of the eligible devices.

28. The system of claim 27, wherein said delivery module is operable to assess communication capabilities of the eligible devices based on a user preference expressed by the user respective of communication via the eligible device.

29. The system of claim 26, wherein said device eligibility assessment module is operable to identify eligibility of a device based on observation of the user via a sensory mechanism of the eligible device.

30. The system of claim 26, wherein said device eligibility assessment module is operable to identify eligibility of a device based on detection of user interaction with the device.

31. The system of claim 26, wherein said device eligibility assessment module is operable to identify eligibility of a device based on knowledge of common location of the user and the eligible device.

32. The system of claim 1, wherein said delivery module is operable to determine the manner of notification delivery based on a manually expressed user preference relating to communication of the notification.

33. The system of claim 1, wherein said input is further receptive of a user response to a delivered notification, the system further comprising a user response assessment module operable to observe emotional content of the user response based on response characteristics relating to intensity, and to infer at least one of a favorable user reaction and an unfavorable user reaction to the delivered notification based on the emotional content, wherein said delivery module is operable to incorporate knowledge of a type of the user reaction into future communications with the user.

34. The system of claim 1, wherein said delivery module is operable to discard expired notifications based on a comparison between a time of expiration associated with the notification and a current time.

35. The system of claim 1, wherein said delivery module is operable to identify an older notification that has been superseded by a newer notification of similar type, and to discard the older notification.

36. An information notification method, comprising:
receiving at least one of:
(a) activity information relating to at least one selected user activity category; and
(b) environment information relating to at least one selected user environment category;
determining a manner of notification delivery based on at least one of the user activity category and the user environment category; and
communicating a notification to the user in accordance with the manner of delivery.

37. The method of claim 36, further comprising selecting at least one of plural, predefined user activity categories based on sensed user activity.

38. The method of claim 37, further comprising sensing user interaction with an electronic device via the electronic device.

39. The method of claim 37, further comprising sensing user interaction with a user environment via an electronic device proximate to the user environment and having a sensory function.

40. The method of claim 36, further comprising selecting at least one of plural, predefined user activity categories based on a time-specific user activity schedule and a current time.

41. The method of claim 36, further comprising selecting at least one of plural, predefined user activity categories based on learned user behavior patterns resulting from monitored user activity.

42. The method of claim 36, further comprising selecting at least one of plural, predefined user environment categories based on a user location and predefined environment categories associated in a datastore with at least one location.

43. The method of claim 42, further comprising sensing the user location based on a global positioning system function of a portable electronic device of the user.

44. The method of claim 42, further comprising sensing the user location based on a time-specific and location-specific user activity schedule and a current time.

45. The method of claim 42, further comprising sensing the user location based on user interaction with an electronic device at a known location.

46. The method of claim 36, further comprising selecting at least one of plural, predefined user environment categories based on sensed environmental stimuli in proximity to the user.

47. The method of claim 36, further comprising selecting at least one of plural, predefined user environment categories based on learned environment behavior patterns resulting from monitored environment behavior.

48. The method of claim 36, further comprising determining the manner of notification delivery based on an information category relating to the notification.

49. The method of claim 48, further comprising selecting at least one of plural information categories based on a priority of the notification.

50. The method of claim 49, further comprising determining the manner of delivery based on a comparison between the priority of the notification and a priority relating to a user activity.

51. The method of claim 48, further comprising selecting at least one of plural information categories based on a confidentiality level of the notification.

52. The method of claim 48, further comprising selecting at least one of plural information categories based on content of the notification.

53. The method of claim 48, further comprising selecting at least one of plural information categories based on at least one medium of the notification selected from at least one of audio, video, text, image, vibration, sound, and light emission.

54. The method of claim 36, further comprising determining whether a manner of delivery is available that satisfies predetermined conditions relating to convenience, courtesy, timeliness, naturalness, and safety, wherein the manner of delivery relates to a medium of the notification in view of communication capabilities of eligible devices, wherein the medium is selected from at least one of audio, video, text, image, vibration, sound, and light emission.

55. The method of claim 54, further comprising determining that communication of an attention grabbing gesture satisfies the predetermined conditions.

56. The method of claim 55, further comprising:
receiving a user response to the attention grabbing gesture; and
determining whether a manner of delivery is available that satisfies the predetermined conditions based on the user response.

57. The method of claim 54, further comprising delaying communication of the notification until the predetermined conditions are satisfied.

58. The method of claim 54, further comprising determining that communication of a full version of the notification satisfies the predetermined conditions.

59. The method of claim 54, further comprising determining that communication of a summarized version of the notification satisfies the predetermined conditions.

60. The method of claim 54, further determining whether a manner of delivery is available that satisfies the predetermined conditions based on at least one communication capability of at least one device eligible to communicate the notification to the user.

61. The method of claim 36, further comprising assessing eligibility of devices to communicate the notification to the user.

62. The method of claim 61, further comprising selecting one of plural eligible devices to communicate the notification based on varying communication capabilities of the eligible devices.

63. The method of claim 62, further comprising assessing communication capabilities of the eligible devices based on a user preference expressed by the user respective of communication via the eligible device.

64. The method of claim 61, further comprising identifying eligibility of a device based on observation of the user via a sensory mechanism of the eligible device.

65. The method of claim 61, further comprising identifying eligibility of a device based on detection of user interaction with the device.

66. The method of claim 61, further comprising identifying eligibility of a device based on knowledge of common location of the user and the eligible device.

67. The method of claim 36, further comprising determining the manner of notification delivery based on a manually expressed user preference relating to communication of the notification.

68. The method of claim 36, further comprising:
receiving a user response to a delivered notification;
observing emotional content of the user response based on response characteristics relating to intensity;
inferring at least one of a favorable user reaction and unfavorable user reaction to the delivered notification based on the emotional content; and
incorporating knowledge of a type of the user reaction into future communications with the user.

69. The method of claim 36, further comprising discarding expired notifications based on a comparison between a time of expiration associated with the notification and a current time.

70. The method of claim 36, further comprising:
identifying an older notification that has been superceded by a newer notification of similar type; and
discarding the older notification.

71. A device enrollment method for use with an information notification delivery system, comprising:
establishing communication with an enrolling device over a communications network;
receiving device characteristic information from the enrolling device relating to device characteristics including device type and input/output capabilities of the device;
registering the device characteristic information in memory;
transmitting an application programming interface to the enrolling device based on the device type that is operable to render the enrolling device compliant with notification delivery functionality of the notification delivery system.

72. The method of claim 71, wherein the application program interface causes the enrolling device to send its original notifications to the information notification delivery system.

73. The method of claim 71, wherein the application program interface causes the enrolling device to deliver notifications received from the information notification delivery system to users in accordance with instructions from the information notification delivery system.

74. The method of claim 71, wherein the application program interface causes the enrolling device to communicate captured sounds and images, user schedules, and device states to the information notification delivery system.

75. The method of claim 1, wherein the information notification system is at least one of:
(a) maintained at a central location and adapted to register and employ plural devices; and
(b) maintained on at least two compliant devices of plural compliant devices in a distributed fashion.

76. A method of operation for a device operable to perform information notification delivery in a convenient, courteous, timely, natural, and safe manner, comprising:
receiving at least one of:
(a) activity information relating to at least one selected user activity category; and
(b) environment information relating to at least one selected user environment category;
determining a manner of notification delivery based on the user activity category and the user environment category; and
communicating the notification to the user in accordance with the manner of delivery.

77. The method of claim 76, further comprising making a determination whether a manner of notification delivery is available that satisfies predetermined conditions relating to at least one of convenience, courtesy, timeliness, naturalness, and safety, wherein the determination includes evaluating a majority of the following information notification delivery categories:
(a) an attention grabbing gesture;
(b) a notification summary; and
(c) a full notification.

78. The method of claim 77, further comprising:
communicating an attention grabbing gesture to the user;
receiving user feedback in response to the attention grabbing gesture; and
making the determination based on the user feedback.

79. The method of claim 76, further comprising:
sensing user activity; and
selecting the user activity category based on the user activity.

80. The method of claim 76, further comprising:
sensing environmental stimuli in a vicinity of the device;
sensing user collocation with the device; and
selecting the user environment category based on the sensed stimuli.
